(19) United States
(12) Patent Application Publication
(10) Pub. No.: US 2024/0186036 A1
(43) Pub. Date: Jun. 6, 2024

(54) R-T-B-BASED RARE EARTH MAGNET AND PRODUCTION METHOD THEREOF

(71) Applicant: TOYOTA JIDOSHA KABUSHIKI KAISHA, Toyota-shi (JP)

(72) Inventors: Noritsugu Sakuma, Mishima-shi (JP); Tetsuya Shoji, Susono-shi (JP); Akihito Kinoshita, Mishima-shi (JP)

(21) Appl. No.: 18/488,076

(22) Filed: Oct. 17, 2023

(30) Foreign Application Priority Data
Oct. 19, 2022 (JP) 2022-167810

(51) Int. Cl. H01F 1/057

(52) U.S. Cl. CPC H01F 1/057

(57) ABSTRACT

The R-T-B-based rare earth magnet 100 of the present disclosure includes a main phase 10 having an R₂T₁₄B-type crystal structure and a grain boundary phase 20. The average grain size of the main phase 10 is from 1.0 to 10,0 μm. The main phase 10 has a core portion 12 and a shell portion 14. The total content ratio of cerium, lanthanum, yttrium and scandium is higher in the core portion 12 than in the shell portion 14. The total content ratio of neodymium, praseodymium, gadolinium, terbium, dysprosium and holmium is higher in the shell portion 14 than in the core portion 12. The R-T-B-based rare earth magnet 100 contains from 0.05 to 0.50 at % of carbon. The content ratio of the carbon is higher in the grain boundary phase 20 than in the main phase 10.

### FIELD

The present disclosure relates to an R-T-B-based rare earth magnet and a production method thereof.

### BACKGROUND

The R-T-B-based rare earth magnet (wherein R is a rare earth element, T is at least either Fe or Co, and B is boron) has a main phase and a grain boundary phase present around the main phase. The main phase is a magnetic phase having an R₂T₁₄B-type crystal structure. This main phase is responsible for obtaining high residual magnetization. However, in the R-T-B-based rare earth magnet, magnetization reversal is likely to occur between main phases, leading to a decrease in the coercive force. Then, various attempts have heretofore been made to enhance the coercive force.

For example, PTL 1 discloses an R-T-B-based rare earth magnet wherein the main phase has an R₂T₁₄B-type crystal structure, the average grain size of the main phase is from 0.8 to 2.8 μm, the content ratio of boron is from 0.71 to 0.86 mass %, the content ratio of carbon is from 0.13 to 0.34 mass %, the content ratio of gallium is from 0.40 to 1.80 mass %, and 0.14≤[C]/([B]+[C])≤0.30 (wherein [B] is the boron content ratio in at % and [C] is the carbon content ratio in at %).

PTL 1 also discloses reducing the content ratio of boron, adjusting the boron content ratio and carbon content ratio so as to form a thick grain boundary phase even when the grain size of the main phase is small, thereby magnetically separating main phases from each other and enhancing the coercive force.

### CITATION LIST

### Patent Literature

[PTL 1] Japanese Unexamined Patent Application Publication No. 2017-157834

### SUMMARY

### Technical Problem

In the R-T-B-based rare earth magnet disclosed in PTL 1, carbon not contributing to development of magnetism is contained in a relatively large amount, and this may contribute to enhancement of the coercive force but unavoidably causes a reduction in the residual magnetization.

Among R-T-B-based rare earth magnets, the most general magnet having an excellent balance between performance and price is an Nd—Fe—B-based rare earth magnet (neodymium magnet). Therefore, the Nd—Fe—B-based rare earth magnet has become rapidly widespread, and it is likely that the amount of Nd used is increased sharply and the amount of Nd used exceeds its production volume in the future. For this reason, attempts are being made to substitute part of Nd with a light rare earth element such as Ce, La, Y, and Sc.

However, when part of Nd is substituted with one or more light rare earth elements, it involves a reduction in the residual magnetization and coercive force, and the one or more light rare earth elements are used by taking various measures so as not to cause any problem in practice. Accordingly, in the case where the R-T-B-based rare earth magnet contains one or more light rare earth elements, if carbon is added in a relatively large amount with the intention of enhancing the coercive force as in the R-T-B-based rare earth magnet disclosed in PTL 1, the reduction in residual magnetization becomes serious.

The present disclosure solves the problems above. More specifically, an object of the present disclosure is to provide an R-T-B-based rare earth magnet ensuring that in the case where the R-T-B-based rare earth magnet contains one or more light rare earth elements, it can enjoy an enhancement of the coercive force while suppressing a reduction in residual magnetization, and a production method thereof.

### Solution to Problem

The present inventors have made many intensive studies to attain the object above and have accomplished the R-T-B-based rare earth magnet of the present disclosure and a production method thereof. The R-T-B-based rare earth magnet of the present disclosure and a production method thereof include the following embodiments.

<1>An R-T-B-based rare earth magnet in which R is a rare earth element, T is at least either Fe or Co, and B is boron, the R-T-B-based rare earth magnet including

a main phase having an R₂T₁₄B-type crystal structure and

a grain boundary phase present around the main phase,

wherein

the average grain size of the main phase is from 1.0 to 10.0 μm,

the main phase has a core portion and a shell portion present around the core portion,

the total content ratio of cerium, lanthanum, yttrium and scandium is higher in the core portion than in the shell portion,

the total content ratio of neodymium, praseodymium, gadolinium, terbium, dysprosium and holmium is higher in the shell portion than in the core portion,

the R-T-B-based rare earth magnet contains from 0.05 to 0.50 at % of carbon, and

the content ratio of the carbon is higher in the grain boundary phase than in the main phase.

<2>The R-T-B-based rare earth magnet according to item <1>, wherein the carbon content ratio is higher in the shell portion than in the core portion.

<3>The R-T-B-based rare earth magnet according to item <1> or <2>, wherein in the shell portion, denoting, in at %, as [C] the carbon content ratio and as [B] the boron content ratio relative to all of the constituent elements of the shell portion, [C] is from 0.25 to 0.75 at % and [C]/([C]+[B]) is from 0.04 to 0.10.

<4>The R-T-B-based rare earth magnet according to item <1> or <2>, wherein the average grain size of the main phase is from 4.0 to 10.0 μm.

<5>A production method of an R-T-B-based rare earth magnet, including

allowing a modifier to diffuse and penetrate into a rare earth magnet precursor, wherein

the rare earth magnet precursor essentially contains, as rare earth elements, one or more elements selected from the group consisting of cerium, lanthanum, yttrium and scandium and has a main phase having an R₂T₁₄B-type crystal structure and a grain boundary phase present around the main phase, the average grain size of the main phase being from 1.0 to 10.0 m,

the modifier contains from 90 to 95 at % of one or more elements selected from the group consisting of neodymium, praseodymium, gadolinium, terbium, dysprosium and holmium and from 5 to 10 at % of carbon, and

from 1.0 to 5.0 mol of the modifier is allowed to diffuse and penetrate per 100 mol of the rare earth magnet precursor.

<6>The production method of an R-T-B-based rare earth magnet according to item <5>, wherein the modifier further contains 5 at % or less of one or more elements other than rare earth elements, and the one or more elements other than rare earth elements are alloyed with one or more elements selected from the group consisting of neodymium, praseodymium, gadolinium, terbium, dysprosium and holmium.

<7>The production method of an R-T-B-based rare earth magnet according to item <5> or <6>, wherein the average grain size of the main phase is from 4.0 to 10.0 μm.

### Advantageous Effects of Invention

According to the present disclosure, the content ratio of carbon is made higher in the grain boundary phase than in the main phase, so that in view of the entire R-T-B-based rare earth magnet, the content ratio of carbon can be reduced. As a result, an R-T-B-based rare earth magnet ensuring that in the case where the R-T-B-based rare earth magnet contains a light rare earth element, it can enjoy an enhancement of the coercive force while suppressing a reduction in residual magnetization, can be provided.

In addition, according to the present disclosure, at the time of allowing a modifier containing one or more rare earth elements other than light rare earth elements to diffuse and penetrate into a rare earth magnet precursor containing one or more light rare earth elements, carbon is added in a predetermined proportion to the modifier. Furthermore, the content ratio of carbon in the modifier is adjusted to be in a range where the content ratio of the one or more rare earth elements other than one or more light rare earth elements, which contributes to the enhancement of coercive force, is not excessively reduced in the modifier. This enables providing a production method of an R-T-B-based rare earth magnet ensuring that even in the case where the R-T-B-based rare earth magnet contains one or more light rare earth elements, it can enjoy an enhancement of the coercive force while suppressing a reduction in residual magnetization.

### BRIEF DESCRIPTION OF DRAWING

FIG. 1 is an explanatory diagram schematically illustrating one example of the R-T-B-based rare earth magnet of the present disclosure.

FIG. 2 is a graph illustrating the relationship between the content ratio (molar ratio) of C in the modifier and the coercive force for respective samples.

FIG. 3 is a graph illustrating a stratification of the graph of FIG. 2 by the content ratio (molar ratio) of Nd in the modifier.

FIG. 4 is a graph illustrating the relationship between Cu content ratio (molar ratio) and C content ratio (molar ratio) in the modifier for respective samples.

FIG. 5 is an explanatory diagram illustrating the results of a line analysis in the vicinity of the interface between main phase and grain boundary phase performed using STEM-EDX for Example 2.

### DESCRIPTION OF EMBODIMENTS

Embodiments of the R-T-B-based rare earth magnet according to the present disclosure and the production method thereof are described in detail below. However, the embodiments described below should not be construed to limit the R-T-B-based rare earth magnet according to the present disclosure and the production method thereof.

Although not bound by theory, regarding the reason why in the case where the R-T-B-based rare earth magnet contains one or more light rare earth elements, it can enjoy an enhancement of the coercive force while suppressing a reduction in the residual magnetization, the knowledge obtained by the present disclosers is described.

In the R-T-B-based rare earth magnet, due to containing one or more light rare earth elements, the residual magnetization and coercive force are reduced. Compared with other permanent magnets, the R-T-B-based rare earth magnet has high residual magnetization, and therefore even when the residual magnetization is reduced due to containing one or more light rare earth elements, the magnet can often be used in practice without problems by compensating for a reduction in the coercive force. However, in the case where the R-T-B-based rare earth magnet contains one or more light rare earth elements, even when the coercive force is enhanced by the addition of carbon as in the rare earth magnet disclosed in PTL 1, if the residual magnetization is further reduced, this becomes a problem in practice.

In the case where the R-T-B-based rare earth magnet contains one or more light rare earth elements, in order to compensate for the coercive force, a modifier containing one or more rare earth elements other than one or more light rare earth elements is allowed to diffuse and penetrate into a rare earth magnet precursor containing one or more light rare earth elements. The modifier diffuses and penetrates into the grain boundary phase present around the main phase and further diffuses and penetrates into the outer periphery of the main phase. In this process, the light rare earth element is substituted with the one or more rare earth elements other than light rare earth elements, and the main phase forms a core portion and a shell portion. Then, the content ratio of the one or more light rare earth elements becomes higher in the core portion than in the shell portion, and the content ratio of the one or more rare earth elements other than light rare earth elements becomes higher in the shell portion than in the core portion. As a result, assuming the same amount of one or more light rare earth elements is used, the coercive force is enhanced and a reduction in the coercive force due to using one or more light rare earth element can be more compensated for than in the case of obtaining an R-T-B-based rare earth magnet by simply replacing one or more rare earth elements other than light rare earth elements by one or more light rare earth elements and blending the raw materials.

The present disclosers have then found that when a modifier containing a predetermined proportion of carbon in addition to one or more rare earth elements other than light rare earth elements are allowed to diffuse and penetrate into a rare earth magnet precursor containing one or more light rare earth elements, a reduction in the residual magnetization is suppressed and furthermore, the coercive force is enhanced. The reason therefor is considered that since the modifier diffuses and penetrates through the grain boundary phase present around the main phase, the abundance of carbon can be increased in the outer peripheral surface region and/or outer peripheral surface neighborhood region of the main phase and the abundance of carbon can be reduced in the inner region of the main phase. Also, the present disclosers have found that when the content ratio of carbon in the modifier exceeds a predetermined range, the content ratio of an element enhancing the coercive force, i.e., one or more rare earth elements other than light rare earth elements, is reduced in the modifier and the coercive force is rather reduced.

More specifically, when carbon is added to a modifier within a range not excessively reducing the content ratio of the coercivity-enhancing element in the modifier and the modifier is allowed to diffuse and penetrate, thereby letting carbon be sufficiently present in a region requiring an increase in the coercive force and letting carbon be present as little as possible in a region not contributing to increasing the coercive force, the content ratio of carbon in the rare earth magnet as a whole is reduced. Then, the present disclosers have found that it is possible to enjoy an enhancement of the coercive force while suppressing a reduction in the residual magnetization.

The constituent features of the R-T-B-based rare earth magnet of the present disclosure and the production method thereof, which are based on the knowledge above, are described below.

### «R-T-B-based Rare Earth Magnet»

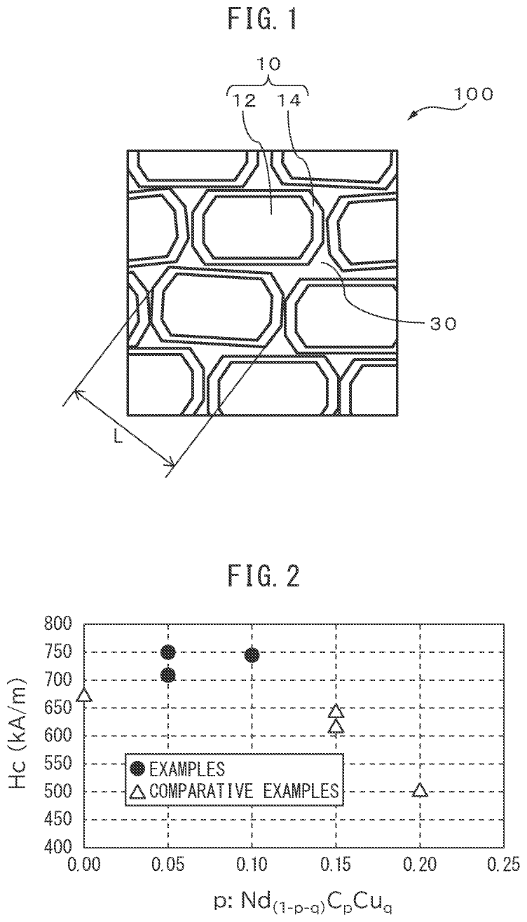

First, the constituent features of the R-T-B-based rare earth magnet of the present disclosure are described by referring to the drawings. FIG. 1 is an explanatory diagram schematically illustrating one example of the R-T-B-based rare earth magnet of the present disclosure. The R-T-B-based rare earth magnet 100 of the present disclosure includes a main phase 10 and a grain boundary phase 20. The grain boundary phase 20 is present around the main phase 10. The main phase 10 has an R₂T₁₄B-type crystal structure. Hereinafter, the phase having an R₂T₁₄B-type crystal structure is sometimes referred to as “R₂T₁₄B phase”. The main phase 10 has a core portion 12 and a shell portion 14. The shell portion 14 is present around the core portion 12. The composition of the R-T-B-based rare earth magnet 100 of the present disclosure, the main phase 10, and the grain boundary phase 20 are described below. Also, with respect to the main phase 10, the core portion 12 and the shell portion 14 are described.

### <Composition>

The R-T-B-based rare earth magnet of the present disclosure contains from 0.05 to 0.50 at % of carbon relative to the entire R-T-B-based rare earth magnet, in addition to R, T and B as basic components. R is a rare earth element, T is at least either Fe or Co, and B is boron.

When the content ratio of carbon is 0.05 at % or more, 0.10 at % or more, 0.15 at % or more, or 0.20 at % or more, the coercive force can be enhanced. On the other hand, when the content ratio of carbon is 0.50 at % or less, 0.49 at % or less, 0.48 at % or less, 0.47 at % or less, 0.46 at % or less, 0.45 at % or less, 0.44 at % or less, 0.43 at % or less, 0.42 at % or less, 0.41 at % or less, 0.40 at % or less, or 0.39 at % or less, a reduction in the residual magnetization can be suppressed. In addition, it is possible to prevent the content ratio of a rare earth element contributing to the enhancement of coercive force from being relatively reduced due to an excessive presence of carbon.

The composition of the R-T-B-based rare earth magnet of the present disclosure may be represented, for example, by the composition formula, in molar ratio, (R²₍₁₋ₓ₎R¹ₓ)_{y}T_{(100-y-v)}B_{z}M¹v·(R³_{(1-p-q)}CₚM²_{q})ₛ but is not limited thereto.

In the composition formula above, R¹ is one or more elements selected from the group consisting of Ce, La, Y and Sc. Ce is cerium, La is lanthanum, Y is yttrium, and Sc is scandium. R² and R³ are one or more elements selected from the group consisting of Nd, Pr, Gd, Tb, Dy and Ho. Nd is neodymium, Pr is praseodymium, Gd is gadolinium, Tb is terbium, Dy is dysprosium, and Ho is holmium. T is either Fe or Co. Fe is iron, and Co is cobalt. B is boron. M¹ is one or more elements selected from the group consisting of Ga, Al, Cu, Au, Ag, Zn, In and Mn, and one or more unavoidable impurity elements. Ga is gallium, Al is aluminum, Cu is copper, Au is gold, Ag is silver, Zn is zinc, In is indium, and Mn is manganese. C is carbon. M² is one or more elements other than rare earth elements, which is alloyed with R³, and one or more unavoidable impurity elements.

In the present description, unless otherwise indicated, the rare earth elements are 17 elements of Sc, Y, La, Ce, Pr, Nd, Pm, Sm, Eu, Gd, Tb, Dy, Ho, Er, Tm, Yb and Lu. Sc is scandium, Y is yttrium, La is lanthanum, Ce is cerium, Pr is praseodymium, Nd is neodymium, Pm is promethium, Sm is samarium, Eu is europium, Gd is gadolinium, Tb is terbium, Dy is dysprosium, Ho is holmium, Er is erbium, Tm is thulium, Yb is ytterbium, and Lu is lutetium.

Also, in the present description, unless otherwise indicated, Sc, Y, La and Ce are light rare earth elements. Pr, Nd, Pm, Sm, Eu and Gd are medium rare earth elements. Tb, Dy, Ho, Er, Tm, Yb and Lu are heavy rare earth elements. Incidentally, in general, the rarity of the heavy rare earth element is high, and the rarity of the light rare earth element is low. The rarity of the medium rare earth element is between the heavy rare earth element and the light rare earth element.

In the composition formula above, R²(1−x)R¹ₓ means that relative to the total of R² and R¹, in molar ratio, R² of (1−x) is present and R¹ of x is present. Similarly, in the composition formula above, R³_{(1-p-q)}CₚM²_{q} means that relative to the total of R³, C and M², in molar ratio, R³ of (1−p−q) is present, C of p is present, and M² of q is present.

In the composition formula above, (R²₍₁₋ₓ₎R¹ₓ)_{y}Fe_{(100-y-z-v)}B_{z}M¹v is derived from the rare earth magnet precursor, and R³(1−p−q)CₚM²q is derived from the modifier. The R-T-B-based rare earth magnet of the present disclosure is obtained by causing s mol of the modifier to diffuse and penetrate per 100 mol of the rare earth magnet precursor. The R-T-B-based rare earth magnet of the present disclosure after the modifier having diffused and penetrated into the rare earth magnet precursor is (100+s) mol. This is represented by the composition formula above. More specifically, the total of R and R² is y mol, T is (100−y−z−v) mol, B is z mol, M¹ is v mol, the total of these is y mol+(100−y−z−v) mol+z mol+v mol=100 mol, and the total of R³, C and M² is mol.

The constituent elements of the R-T-B-based rare earth magnet of the present disclosure represented by the composition formula above are described below.

### <R¹>

R is an essential component for the R-T-B-based rare earth magnet of the present disclosure. As described above, R¹ is one or more elements selected from the group consisting of Ce, La, Y and Sc. R¹ belongs to the light rare earth element and contributes to a reduction of the use amount of middle rare earth elements and heavy rare earth elements which are higher in rarity than light rare earth elements. R¹ is a constituent element of the main phase (R₂T₁₄B phase). At least part of R¹ in the vicinity of the surface layer portion of the main phase is substituted with R³ of the modifier, and the main phase can thereby have a core portion and a shell portion. From the viewpoint of forming a core portion and a shell portion, cerium and lanthanum are preferred as R¹. The reason therefor is that because cerium can be trivalent and tetravalent and is relatively of low stability and lanthanum has a larger ionic radius than other rare earth elements, when the modifier diffuses and penetrates into the grain boundary phase, cerium and/or lanthanum near the surface of the main phase is in particular likely to be discharged into the grain boundary phase.

### <R²>

R² is one or more elements selected from the group consisting of Nd, Pr, Gd, Tb, Dy and Ho and belongs to the rare earth element other than light rare earth elements. Nd, Pr and Gd belong to the medium rare earth element, and Tb, Dy and Ho belong to the heavy rare earth element. That is, R² belongs to the medium rare earth element and/or the heavy rare earth element. In the rare-earth magnet of the present disclosure, in view of the balance between performance and price, it is preferable to increase the content ratios of Nd and Pr, and it is more preferable to increase the content ratio of Nd. In the case where Nd and Pr are caused to be present together as R¹, didymium may be used. R² is a constituent element of the main phase.

<Molar Ratios of R¹ and R²>

In the R-T-B-based rare earth magnet of the present disclosure, R¹ and R² are elements derived from the rare earth magnet precursor. Relative to the total of R¹ and R², in molar ratio, R¹ of x is present, R² of (1−x) is present, and 0.1≤x≤1.0 may be satisfied. This means that R is essential for the R-T-B-based rare earth magnet of the present disclosure.

Since R¹ present in the vicinity of the surface layer portion of the main phase is substituted with R³ of the modifier and the shell portion is thereby formed, R¹ is essentially present even in a small amount. When x is 0.1 or more, the formation of the shell portion can be substantially recognized. In view of forming the shell portion, x may be 0.2 or more, 0.3 or more, 0.4 or more, 0.5 or more, 0.6 or more, 0.7 or more, 0.8 or more, 0.9 or more, or 1.0. When x is 1.0, this means that relative to the total amount of R¹ and R², all are R¹.

When the R₂Fe₁₄B phase (main phase) contains, as the rare earth element, the rare earth elements other than light rare earth elements in a larger amount than the light rare earth element, the residual magnetization and coercive force are high. R¹ (light rare earth element) and R² (rare earth element other than light rare earth elements) are derived from the rare earth magnet precursor. The modifier diffuses and penetrates into the rare earth magnet precursor and consequently, in the vicinity of the surface layer portion of the main phase, at least part of R¹ (light rare earth element) of the rare earth magnet precursor is substituted with R³ (rare earth element other than light rare earth elements) of the modifier, whereby the shell portion is formed. In the case where the main phase has a core portion and a shell portion, the residual magnetization and coercive force of the entire rare earth magnet can be efficiently enhanced by more enhancing the residual magnetization and coercive force in the shell portion than in the core portion. For this reason, even when all are inexpensive R¹ (light rare earth element) in the core portion, it is sufficient if R¹ (light rare earth element) is substituted with R³ (rare earth element other than light rare earth elements) in the shell portion.

<Total Content Ratio of R¹ and R²>

In the composition formula above, the total content ratio of R¹ and R² is denoted as y and may satisfy 12.0<y<20.0. Here, the value of y corresponds to the content ratio (at %) relative to the rare earth magnet precursor.

When y is 12.0 or more, a large amount of αFe phase is not present in the rare earth magnet precursor, and a sufficient amount of the main phase (R₂T₁₄B phase) can be obtained. From this viewpoint, y may be 12.4 or more, 12.8 or more, or 13.2 or more. On the other hand, when y is 20.0 or less, the amount of the grain boundary phase does not become excessive. From this viewpoint, y may be 19.0 or less, 18.0 or less, or 17.0 or less.

### <B>

B constitutes the main phase (R₂T₁₄B phase) and affects the abundance ratios of the main phase and grain boundary phase. In the formula above, the content ratio of B is denoted as z. The value of z corresponds to the content ratio (at %) relative to the rare earth magnet precursor. When z is 20.0 or less, an R-T-B-based rare earth magnet in which the main phase and the grain boundary phase are properly present can be obtained. From this viewpoint, z may be 18.0 or less, 16.0 or less, 14.0 or less, 12.0 or less, 10.0 or less, or 8.0 or less. On the other hand, when z is 5.0 or more, 6.0 or more, or 7.0 or more, a large amount of a phase having a Th₂Zn₁₇-type and/or Th₂Ni₁₇-type crystal structure is unlikely generated, as a result, the formation of the R₂T₁₄B phase is less inhibited.

### <M¹>

M¹ can be contained as long as the properties of the R-T-B-based rare earth magnet of the present disclosure are not impaired. M¹ may contain one or more unavoidable impurity elements. In the present description, the one or more unavoidable impurity elements refer to one or more impurity elements that cannot avoid being contained or causes a significant rise in the production cost for avoiding being contained, such as impurity elements contained in raw materials of the rare earth magnet or impurity elements mixed in the production process. The impurity elements mixed in the production process include an element incorporated, for production reasons, to an extent of not affecting the magnetic properties. In addition, the one or more unavoidable impurity elements include one or more rare earth elements other than the rare earth elements selected as R¹ and R², which are unavoidably mixed for the reasons above.

The element that can be contained within a range not impairing the effects of the R-T-B-based rare earth magnet of the present disclosure and the production method thereof includes Ga, Al, Cu, Au, Ag, Zn, In, and Mn. As long as these elements are present below the upper limit of the content ratio of M¹, they have substantially no effect on the magnetic properties. Therefore, these elements may be treated the same as the unavoidable impurity element. In addition, other than these elements, one or more unavoidable impurity elements may be contained as M¹.

In the formula above, the content ratio of M¹ is denoted as v. The value of v corresponds to the content ratio (at %) relative to the rare earth magnet precursor. When the value of v is 2.0 or less, the magnetic properties of the R-T-B-based rare earth magnet of the present disclosure are not impaired. From this viewpoint, v may be 1.5 or less, 1.0 or less, or 0.5 or less.

In regard to M¹, since it is impossible to completely eliminate Ga, Al, Cu, Au, Ag, Zn, In, and Mn as well as the unavoidable impurity element, even when the lower limit of v is 0.05, 0.1, or 0.2, there is no problem in practical use.

### <T>

T is the remainder of R¹, R², B, and M¹ described hereinabove, and the content ratio of T is denoted as (100−y−z−v). When y, z, and v are adjusted to fall in the ranges above, a main phase and a grain boundary phase present around the main phase are obtained.

T is at least either Fe or Co. In view of stability of the main phase (R₂T₁₄B phase), T is more preferably Fe.

### <R³>

R³ is one or more elements derived from the modifier. The modifier diffuses and penetrates into the inside of the rare earth magnet precursor through a grain boundary phase. At least part of R in the vicinity of the surface layer portion of the main phase is substituted with R³ of the modifier at the time when the modifier diffuses and penetrates into a grain boundary phase, and the shell portion is consequently formed.

R³ is one or more elements selected from the group consisting of Nd, Pr, Gd, Tb, Dy and Ho and belongs to the rare earth element (medium rare earth element and heavy rare earth element) other than light rare earth elements. As described above, at least part of R¹(light rare earth element) in the vicinity of the surface layer portion of the main phase is substituted with R³ (rare earth element other than light rare earth elements) of the modifier, and the concentration of the rare earth element other than light rare earth elements increases in the shell portion. As a result, the residual magnetization and coercive force of the R-T-B-based rare earth magnet of present disclosure is enhanced.

### <C>

C is an element derived from the modifier. The modifier diffuses and penetrates into the inside of the rare earth magnet precursor through a grain boundary phase. This leads to the presence of many C (carbons) in the outer peripheral surface region and/or outer peripheral surface neighborhood region of the main phase and contributes to enhancement of the coercive force.

In the R-T-B-based rare earth magnet of the present disclosure, as described above, the content ratio of C is from 0.05 to 0.50 at %. In the composition formula above, the content ratio (at %) of C is {(p×s)/(100+s)}×100 and thus satisfies 0.05≤{(p×q)/(100+q)}×10050.50.

### <M²>

M² is one or more element other than rare earth elements, and M² is alloyed with R³, and one or more unavoidable impurity element. Typically, M² is an element other than rare earth elements, which decreases the melting point of the modifier having a composition represented by R³(1−p−q)CₚM²_{q} below the melting point of R³, and one or more unavoidable impurity elements. Examples of M² other than an unavoidable impurity element include one or more elements selected from the group consisting of Cu, Al, Co, and Fe, with Cu being particularly preferred. Here, in the present description, the unavoidable impurity element refers to an impurity element that cannot avoid being contained or causes a significant rise in the production cost for avoiding being contained, such as impurity elements contained in raw materials of the rare earth magnet or impurity elements mixed in the manufacturing process. The impurity elements mixed in the production process include an element incorporated, for production reasons, to an extent of not affecting the magnetic properties. In addition, the unavoidable impurity element includes one or more rare earth elements other than the rare earth elements selected as R³, which is unavoidably mixed for the reasons above.

M² (excluding rare earth elements as an unavoidable impurity) does not contribute to development of magnetism and causes a reduction in the residual magnetization and therefore, if the diffusion and penetration of the modifier can be ensured, the content ratio of M² is preferably as small as possible. The content ratio of M² in the modifier is described below.

<Molar Ratios of R³, C and M²>

R³, C and M² are elements constituting the modifier having a composition represented by R³_{(1-p-q)}CₚM²_{q}.

p is the molar ratio of C (carbon) in the modifier. When p is 0.05 or more, the modifier can be allowed to diffuse and penetrate into the rare earth magnet precursor by decreasing the melting point of the modifier, and this contributes to enhancement of the coercive force. From this viewpoint, p may be 0.06 or more, or 0.07 or more. On the other hand, when p is 0.10 or less, the content ratio of R³ contributing to enhancement of the coercive force is not reduced. In addition, diffusion of excessive C into the rare earth magnet precursor can be prevented, as a result, reduction in the residual magnetization can be suppressed. From these viewpoints, p may be 0.09 or less, or 0.08 or less. Incidentally, for example, when p is from 0.05 to 0.10, the content ratio of C (carbon) relative to the entire modifier is from 5 to 10 at %.

q is the molar ratio of M² in the modifier. When q is 0.05 or less, the reduction of residual magnetization does not pose a problem in practice. From this viewpoint, q may be 0.04 or less, 0.03 or less, 0.02 or less, or 0.01 or less, and may even be 0. Incidentally, for example, when q is 0.05 or less, the content ratio of M² relative to the entire modifier is 5 at % or less.

The molar ratio of R³ in the modifier is the remainder of C and M² and is denoted as (1−p-q).

<Molar Ratios of Element Derived from Rare Earth Magnet Precursor and Element Derived from Modifier>

The composition formula above is meant to contain s mol of the modifier per 100 mol of the rare earth magnet precursor.

When s is 1.0 or more, at least part of R¹ (light rare earth element) of the main phase of the rare earth magnet precursor can be substituted with R³ (rare earth element other than light rare earth elements) of the modifier, and the shell portion can be formed. As a result, the residual magnetization and coercive force of the rare earth magnet of the present disclosure are enhanced.

In addition, many C (carbons) are present in the outer peripheral surface region and/or outer peripheral surface neighborhood region of the main phase, and the coercive force is further enhanced. From this viewpoint, s may be 2.0 or more, or 3.0 or more. On the other hand, when s is 5.0 or less, the residual magnetization is not reduced due to excessive C (carbon). From this viewpoint, s may be 4.0 or less, or 3.0 or less.

The main phase and the grain boundary phase are described below. With respect to the main phase, the core portion and the shell portion are also described.

### <Main Phase>

The main phase has an R₂T₁₄B-type crystal structure. The reason why the description of the R₂Fe₁₄B “type” is used is that the main phase (the crystal structure) can contain an element other than R, T and B as a substitutional and/or interstitial element.

The average grain size of the main phase is from 1.0 to 10.0 μm. The melting point of the modifier for obtaining the rare earth magnet of the present disclosure is relatively high. When the average grain size of the main phase is 1.0 μm or more, coarsening of the main phase can be substantially avoided even when the modifier has diffused and penetrated. From this viewpoint, the average grain size of the main phase may be 1.1 μm or more, 1.3 μm or more, 1.5 μm or more, 2.0 μm or more, 2.5 μm or more, 3.0 μm or more, 3.5 μm or more, 4.0 μm or more, 4.5 μm or more, 5.0 μm or more, or 5.5 μm or more. When the average grain size of the main phase is 10.0 μm or less, it is unlikely that the desired residual magnetization and/or coercive force are reduced due to the grain size of the main phase. From this viewpoint, the average grain size of the main phase may be 9.0 μm or less, 8.0 μm or less, 7.0 μm or less, or 6.0 μm or less.

In the case of adding carbon without using a modifier as in PTL 1, it is believed that the average grain size of the main phase must be 2.8 μm or less so as to enhance the coercive force. For obtaining the R-T-B-based rare earth magnet of the present disclosure, diffusion and penetration of a modifier is effected, and this leads to the presence of many C (carbons) in the outer peripheral surface region and/or outer peripheral surface neighborhood region of the main surface. Therefore, the coercive force is enhanced even when the average grain size of the main phase is relatively large. From this viewpoint, the average grain size of the main phase may be 4.0 μm or more, 4.1 μm or more, 4.2 μm or more, 4.3 μm or more, 4.4 μm or more, 4.5 μm or more, or 4.6 μm or more.

The “average grain size” is an average of maximum lengths of main phases. The “average of maximum lengths” means an average of respective maximum lengths of main phases present in a certain area after defining the certain area in a scanning electron microscope image or a transmission electron microscope image. For example, when the cross-sectional shape of the main phase is oval, the length of the major axis is the maximum length. For example, when the cross-section of the main phase is quadrangular, the length of a longer diagonal line is the maximum length. In addition, since the main phase of the rare earth magnet of the present disclosure has a core portion and a shell portion, the maximum length of the main phase is a maximum length including the shell portion. For example, in the case illustrated in FIG. 1, the maximum length of the main phase 10 is the length indicated by L.

### <Core Portion and Shell Portion>

The main phase of the R-T-B-based rare earth magnet of the present disclosure has a core portion and a shell portion. The shell portion is present around the core portion.

The residual magnetization and coercive force of the entire rare earth magnet can be increased by more increasing the residual magnetization and coercive force in the shell portion than in the core portion. In the R-T-B-based rare earth magnet of the present disclosure, the light rare earth element in the rare earth magnet precursor is discharged from the shell portion to the grain boundary phase due to diffusion and penetration of the modifier, and the rare earth element other than light rare earth elements in the modifier has diffused and penetrated into the shell portion from the grain boundary phase, which is advantageous for enhancing the residual magnetization and coercive force.

The rare earth magnet precursor for obtaining the rare earth magnet of the present disclosure essentially contains, as rare earth elements, one or more elements selected from the group consisting of cerium, lanthanum, yttrium and scandium. Accordingly, in the R-T-B-based rare earth magnet of the present disclosure, the total content ratio of cerium, lanthanum, yttrium and scandium is higher in the core portion than in the shell portion. For example, in the case where the R-T-B-based rare earth magnet of the present disclosure contains cerium and lanthanum and does not contain yttrium and scandium, the total content ratio of cerium, lanthanum, yttrium and scandium is the total content ratio of cerium and lanthanum. The total content ratio of cerium, lanthanum, yttrium and scandium in the core portion may be higher than the total content ratio of cerium, lanthanum, yttrium and scandium in the shell portion, for example, by 1.1 times or more, 1.3 times or more, or 1.5 times or more and by 10.0 times or less, 9.0 times or less, 8.0 times or less, 7.0 times or less, 6.0 times or less, 5.0 times or less, 4.5 times or less, 4.0 times or less, 3.0 times or less, or 2.0 times or less.

The modifier for obtaining the rare earth magnet of the present disclosure contains one or more elements selected from the group consisting of neodymium, praseodymium, gadolinium, terbium, dysprosium and holmium. Accordingly, in the R-T-B-based rare earth magnet of the present disclosure, the total content ratio of neodymium, praseodymium, gadolinium, terbium, dysprosium and holmium is higher in the shell portion than in the core portion. For example, in the case where the R-T-B-based rare earth magnet of the present disclosure contains neodymium and praseodymium and does not contain gadolinium, terbium, dysprosium and holmium, the total content ratio of neodymium, praseodymium, gadolinium, terbium, dysprosium and holmium is the total content ratio of neodymium and praseodymium. The total content ratio of neodymium, praseodymium, gadolinium, terbium, dysprosium and holmium in the shell portion may be higher than the total content ratio of neodymium, praseodymium, gadolinium, terbium, dysprosium and holmium in the core portion, for example, by 1.1 times or more, 1.3 times or more, or 1.5 times or more and by 10.0 times or less, 9.0 times or less, 8.0 times or less, 7.0 times or less, 6.0 times or less, 5.0 times or less, 4.5 times or less, 4.0 times or less, 3.0 times or less, or 2.0 times or less.

Since the modifier contains carbon, part of carbon having diffused and penetrated into the grain boundary phase is present in the outer peripheral surface region and/or outer peripheral surface neighborhood region of the main phase. At this time, part of boron in the main phase (R₂T₁₄B phase) is considered to be substituted with carbon. In addition, it is considered that carbon in the modifier may diffuse and penetrate into the shell portion but does not diffuse deep into the core portion. Therefore, the content ratio of carbon is higher in the shell portion than in the core portion.

Also, the degree to which boron is substituted with carbon in the shell portion is expressed by the content ratio [C] (at %) of carbon relative to all the constituent elements of the shell portion and the substitution ratio. The substitution ratio can be expressed as [C]/([C]+[B]). As described above, [C] is the content ratio (at %) of carbon in the shell portion relative to all the constituents of the shell portion. [B] is the content ratio (at %) of boron in the shell portion relative to all the constituent elements of the shell portion.

[C] is determined by subjecting the shell portion to STEM-EDX analysis. [B] is determined by subtracting the [C] value (at %) from 5.88 at % that is the boron content ratio in the theoretical composition of the main phase (R₂T₁₄B phase).

When [C] is 0.25 at % or more, 0.30 at % or more, or 0.35 at % or more, the coercive force can be enhanced by carbon. On the other hand, when [C] is 0.50 at % or less, 0.45 at % or less, or 0.40 at % or less, the reduction in residual magnetization can be suppressed.

When [C]/([C]+[B]) is 0.04 or more, 0.05 or more, or 0.06 or more, the coercive force is enhanced by carbon. On the other hand, when [C]/([C]+[B]) is 0.10 or less, 0.09 or less, 0.08 or less, or 0.07 or less, the reduction in residual magnetization can be suppressed.

### <Grain Boundary Phase>

The grain boundary phase is present around the main phase. In the grain boundary phase, various phases other than R₂T₁₄B phase are mixed. These phases include a phase having an incomplete crystal structure. The grain boundary phase is therefore difficult to represent using a crystal structure, but, as for the composition thereof, in the rare earth magnet precursor, i.e., before diffusion and penetration of the modifier, the content ratio of the rare earth element is higher in the entire grain boundary phase than in the main phase (R₂T₁₄B phase). Accordingly, the grain boundary phase is sometimes referred to as “R-rich phase”, “rare earth element-rich phase” or “rare earth-rich phase”.

Since the modifier diffuses and penetrates through the grain boundary phase, the content ratio of the rare earth element in the grain boundary phase is increased after diffusion and penetration of the modifier. Also, the diffusion and penetration of the modifier leads to the presence of carbon.

Part of carbon having diffused and penetrated into the grain boundary phase further diffuses and penetrates into the outer peripheral surface region and/or outer peripheral surface neighborhood region of the main phase, but many of carbons having diffused and penetrated into the grain boundary phase remain in the grain boundary phase. Therefore, the content ratio of carbon is higher in the grain boundary phase than in the main phase. The content ratio of carbon in the grain boundary phase may be higher than the content ratio of carbon in the main phase, for example, by 1.1 times or more, 1.3 times or more, or 1.5 times or more and by 30 times or less, 25 times or less, 20 times or less, 15 times or less, 10 times or less, 9.0 times or less, 8.0 times or less, 7.0 times or less, 6.0 times or less, 5.0 times or less, 4.0 times or less, 3.0 times or less, or 2.0 times or less.

### «Production Method»

The production method of the R-T-B-based rare earth magnet of the present disclosure is described below.

The production method of the R-T-B-based rare earth magnet of the present disclosure includes allowing a modifier to diffuse and penetrate into a rare earth magnet precursor. The rare earth magnet precursor and the modifier are described below.

### <Rare Earth Magnet Precursor>

The rare earth magnet precursor essentially contains, as rare earth elements, one or more elements selected from the group consisting of cerium, lanthanum, yttrium and scandium. As described above, the composition of the rare earth magnet precursor may be represented, for example, by the composition formula, in molar ratio, (R²₍₁₋ₓ₎R¹ₓ)_{y}T(100−y−z−v)B_{z}M¹ᵥ but is not limited thereto.

The rare earth magnet precursor has a main phase and a grain boundary phase. The main phase has an R₂T₁₄B-type crystal structure. The grain boundary phase is present around the main phase. The average grain size of the main phase is from 1.0 to 10 μm.

Regarding the rare earth magnet precursor, the composition and the main phase as well as the grain boundary phase are as described in “«R-T-B-Based Rare Earth Magnet».

The rare earth magnet precursor can be prepared using a known production method of a rare earth sintered magnet. The rare earth sintered magnet means a magnet obtained by subjecting a magnetic powder having a main phase of micro-level size to pressureless high temperature sintering.

The preparation of the rare earth magnet precursor may be performed as follows, for example, but is not limited thereto.

In the case where the composition of the rare earth magnet precursor is represented by the composition formula, in molar ratio, (R²₍₁₋ₓ₎R¹ₓ)_{y}Fe_{(100-y-w-z-v)}Co_{w}B_{z}M¹ᵥ, a magnetic ribbon is obtained by cooling a molten metal having this composition at such a rate that the average grain size of the main phase (R₂T₁₄B phase) becomes 1.0 to 10.0 μm. Such a cooling rate is, for example, from 1 to 1,000° C./s. Also, the method for obtaining a magnetic powder at such a cooling rate includes, for example, a strip casting method and a book molding method. The composition of the molten metal is fundamentally the same as the overall composition of the rare earth magnet precursor, but as for the element that may be consumed in the process of producing the rare earth magnet precursor, the overall composition can be made up taking into account the consumption.

A magnetic powder obtained by pulverizing the magnetic ribbon above is compacted. The powder compacting may be performed in a magnetic field. This makes it possible to impart anisotropy to the rare earth magnet after sintering. The molding pressure during powder compacting may be, for example, 50 MPa or more, 100 MPa or more, 200 MPa or more, or 300 MPa or more, and may be 1,000 MPa or less, 800 MPa or less, or 600 MPa or less. The magnetic field applied may be 0.1 T or more, 0.5 T or more, 1 T or more, 1.5 T or more, or 2.0 T or more, and may be 10.0 T or less, 8.0 T or less, 6.0 T or less, or 4.0 T or less. The pulverization method includes, for example, a method where the magnetic ribbon is coarsely pulverized and then further pulverized by means of a jet mill, etc. The method for coarse pulverization includes, for example, a method using a hammer mill, a method of embrittling the magnetic ribbon by hydrogen, and a combination thereof.

The above green compact is subjected to pressureless sintering to obtain a rare earth magnet precursor. In order to sinter the green compact without applying a pressure and thereby increase the density of the sintered body, the green compact is sintered at a high temperature over a long period of time. The sintering temperature may be, for example, 900° C. or more, 950° C. or more, or 1,000° C. or more, and may be 1,100° C. or less, 1,050° C. or less, or 1,040° C. or less. The sintering time may be, for example, 1 hour or more, 2 hours or more, 3 hours or more, or 4 hours or more, and may be 24 hours or less, 18 hours or less, 12 hours or less, or 6 hours or less. In order to suppress oxidation of the green compact during sintering, the sintering atmosphere is preferably an inert gas atmosphere. The inert gas atmosphere includes a nitrogen gas atmosphere.

### <Modifier>

The modifier contains from 90 to 95 at % of one or more elements selected from the group consisting of neodymium, praseodymium, gadolinium, terbium, dysprosium and holmium and from 5 to 10 at % of carbon. The modifier may further contain 5 at % or less of an element other than rare earth elements, which is alloyed with one or more elements selected from the group consisting of neodymium, praseodymium, gadolinium, terbium, dysprosium and holmium. The composition of the modifier may be represented by the composition formula, in molar ratio, (R³_{(1-p-q)}CₚM²_{q}) but is not limited thereto.

Regarding the modifier, the composition is as described in “«R-T-B-Based Rare Earth Magnet»”.

The method for preparing the modifier includes, for example, a method where a molten metal having the composition of the modifier is cooled using a liquid quenching method or a strip casting method, etc. to obtain a ribbon, etc. In these methods, the molten metal is rapidly cooled, and therefore segregation is less likely to occur in the modifier. In addition, the production method of the modifier includes, for example, a method where a molten metal having the composition of the modifier is cast in a casting mold such as book mold. In this method, a large amount of modifier is relatively easily obtained. In order to decrease the segregation of the modifier, the book mold is preferably made of a material having a high thermal conductivity. Furthermore, the casting material is preferably heat-treated for homogenization so as to suppress segregation. Moreover, the method for preparing the modifier includes a method where raw materials of the modifier are loaded into a container, the raw materials are arc-melted in the container, and the melt is cooled to obtain an ingot. In this method, even when the melting point of the raw material is high, the modifier can be relatively easily obtained. From the viewpoint of reducing segregation of the modifier, the ingot is preferably heat-treated for homogenization.

### <Diffusion and Penetration>

From 1.0 to 5.0 mol of the modifier is allowed to diffuse and penetrate per 100 mol of the rare earth magnet precursor. The diffusion and penetration ratio of the modifier relative to the rare earth magnet precursor is as described in “<<R-T-B-Based Rare Earth Magnet»”.

The modifier is caused to diffuse and penetrate into the rare earth magnet precursor at a temperature of not less than the melting point of the modifier and from 800 to 1,000° C. The diffusion and penetration temperature may be, as long as it is not less than the melting point of the modifier, 820° C. or more, 840° C. or more, 860° C. or more, 880° C. or more, 900° C. or more, 910° C. or more, 920° C. or more, 930° C. or more, 940° C. or more, or 950° C. or more, and may be 990° C. or less, 980° C. or less, 970° C. or less, 970° C. or less, or 960° C. or less.

As long as the main phase of the rare earth magnet precursor is not coarsened during diffusion and penetration of the modifier, the diffusion and penetration temperature is preferably higher for forming a predetermined shell portion. When the diffusion and penetration temperature is 1,000° C. or less, 990° C. or less, 980° C. or less, 970° C. or less, 970° C. or less, or 960° C. or less, coarsening of the main phase of the rare earth magnet precursor can be suppressed.

### <Variation>

The R-T-B-based rare earth magnet of the present disclosure and the production method thereof can be appropriately varied within the scope of the claims.

For example, in the R-T-B-based rare earth magnet, the shell portion is sufficient if it is present around (outside) the core portion. That is, the shell portion may be present directly or indirectly around (outside) the core portion. The shell portion being present indirectly around (outside) the core portion means that an overlapping part of the core portion and the shell portion may be present between the core portion and the shell portion. The overlapping part of the core portion and the shell portion is a transition part from the core portion to the shell portion.

In addition, as for the production method, for example, after the diffusion and penetration of the modifier into the rare earth magnet precursor, the precursor may be cooled and directly used as the R-T-B-based rare earth magnet of the present disclosure, or the rare earth magnet after cooling may be further heat-treated and used as the R-T-B-based rare earth magnet of the present disclosure. Although not bound by theory, it is believed that due to this heat treatment, part of the grain boundary phase after the modifier has diffused and penetrated is melted without altering (without melting) the structure of the main phase and the melt is solidified to evenly cover the main phase, contributing the enhancement of the coercive force.

In order to enjoy the effect of enhancing the coercive force, the heat treatment temperature is preferably 450° C. or more, more preferably 475° C. or more, still more preferably 500° C. or more. On the other hand, in order to avoid alteration of the structure of the main phase, the heat treatment temperature is preferably 600° C. or less, more preferably 575° C. or less, still more preferably 550° C. or less.

The heat treatment is preferably performed in an inert gas atmosphere for avoiding oxidation of the R-T-B-based rare earth magnet of the present disclosure. The inert gas atmosphere includes a nitrogen gas atmosphere. Note that in the present description, the hereinbefore-described heat treatment after diffusion and penetration is sometimes referred to as “heat treatment for optimization”.

### Examples

The R-T-B-based rare earth magnet of the present disclosure and the production method thereof are described more specifically below by referring to Examples and Comparative Examples. Incidentally, the R-T-B-based rare earth magnet of the present disclosure and the production method thereof are not limited to the conditions employed in the following Examples.

### <Preparation of Sample>

A strip cast material having an overall composition shown in Table 1 was pulverized by hydrogenation and then further pulverized using a jet mill to obtain a magnetic powder. The magnetic powder was molded in a magnetic field to obtain a green compact. Subsequently, the green compact was subjected to pressureless sintering at 1,060° C. over 4 hours to obtain a sintered body. Then, a modifier having the composition of Table 1 was allowed to diffuse and penetrate into the sintered body. The diffusion and penetration conditions were 950° C. and 165 minutes. Furthermore, the sintered body after diffusion and penetration was subjected to heat treatment for optimization. In this way, samples of Examples 1 to 3 and Comparative Examples 1 to 4 were obtained. The conditions of the heat treatment for optimization were 500° C. and 60 minutes.

### <Evaluation>

Each sample was cut out to a size of 2 mm×2 mm×2 mm and measured for magnetic properties. In the measurement, Vibrating Sample Magnetometer (VSM) was used. The magnetic properties were measured at room temperature. Each sample was subjected to structure observation using SEM, and the average grain size of the main phase was determined by the method described in “«R-T-B-Based Rare Earth Magnet»”. Also, the C concentration in the grain boundary phase was measured using EPMA. In addition, component analysis in the vicinity of the interface between the main phase and the grain boundary phase was performed using STEM-EDX.

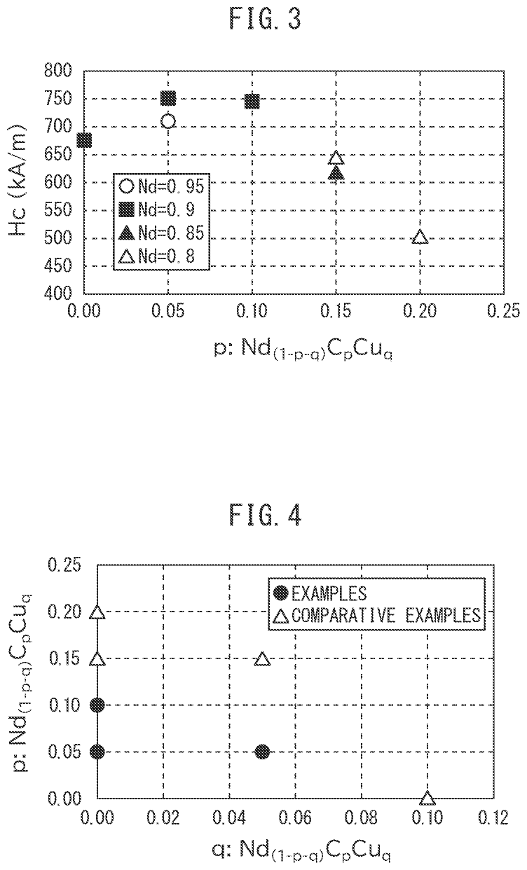

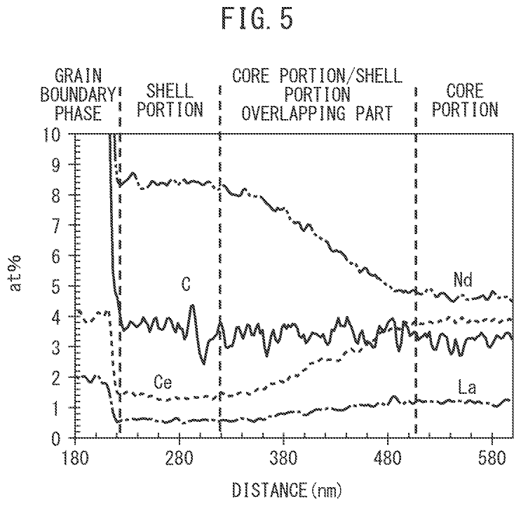

The results are shown in Table 1. FIG. 2 is a graph illustrating the relationship between the content ratio (molar ratio) of C in the modifier and the coercive force for respective samples. FIG. 3 is a graph illustrating a stratification of the graph of FIG. 2 by the content ratio (molar ratio) of Nd in the modifier. FIG. 4 is a graph illustrating the relationship between Cu content ratio (molar ratio) and C content ratio (molar ratio) in the modifier for respective samples. FIG. 5 is an explanatory diagram illustrating the results of a line analysis in the vicinity of the interface between main phase and grain boundary phase performed using STEM-EDX for Example 2.

TABLE 1-1

| | Rare Earth Magnet Precursor | | | | | | | | | |
|---|---|---|---|---|---|---|---|---|---|---|
| | | Average | | | | Diffusion | | | Conditions | |
| | | Grain Size | | | | and | Diffusion | | of Heat | |
| | | of Main | Modifier Composition | | | Penetration | and | | Treatment | |
| | Composition | Phase | (molar ratio) | | | Amount | Penetration | | for | |
| | (at %) | (μm) | Nd | Cu | C | (mol) | Conditions | | Optimization | |
| Example 1 | (Nd0.51Ce0.37La0.12)13.1FebalB6Ga0.3Cu0.1 | 4.6 | 0.95 | 0 | 0.05 | 4.2 | 950° | C. | 500° | C. |
| Example 2 | (Nd0.51Ce0.37La0.12)13.1FebalB6Ga0.3Cu0.1 | 4.6 | 0.90 | 0 | 0.10 | 4.1 | 165 | min | 60 | min |
| Example 3 | (Nd0.51Ce0.37La0.12)13.1FebalB6Ga0.3Cu0.1 | 4.6 | 0.90 | 0.05 | 0.05 | 4.1 | | | | |
| Comparative | (Nd0.51Ce0.37La0.12)13.1FebalB6Ga0.3Cu0.1 | 4.6 | 0.90 | 0.10 | 0 | 4.1 | | | | |
| Example 1 | | | | | | | | | | |
| Comparative | (Nd0.51Ce0.37La0.12)13.1FebalB6Ga0.3Cu0.1 | 4.6 | 0.85 | 0 | 0.15 | 4.0 | | | | |
| Example 2 | | | | | | | | | | |
| Comparative | (Nd0.51Ce0.37La0.12)13.1FebalB6Ga0.3Cu0.1 | 4.6 | 0.80 | 0 | 0.20 | 3.8 | | | | |
| Example 3 | | | | | | | | | | |
| Comparative | (Nd0.51Ce0.37La0.12)13.1FebalB6Ga0.3Cu0.1 | 4.6 | 0.80 | 0.05 | 0.15 | 3.8 | | | | |
| Example 4 | | | | | | | | | | |

TABLE 1-2

| | Content Ratio of | | | | | | Indices for Entire Rare Earth Magnet | | |
|---|---|---|---|---|---|---|---|---|---|
| | C in Grain | Shell Portion | | | Magnetic Properties | | Content Ratio | Content Ratio | |
| | Boundary Phase | [C] | [B] | [C]/ | Hc | Br | of C | of B | [C]/ |
| | (at %) | (at %) | (at %) | ([C] + [B]) | (kA/m) | (T) | (at %) | (at %) | ([C] + [B]) |
| Example 1 | 22.5 | 0.25 | 5.63 | 0.04 | 709.1 | 1.28 | 0.20 | 5.76 | 0.03 |
| Example 2 | 22.7 | 0.50 | 5.38 | 0.09 | 745.9 | 1.26 | 0.39 | 5.76 | 0.06 |
| Example 3 | 22.4 | 0.25 | 5.63 | 0.04 | 750.9 | 1.27 | 0.20 | 5.76 | 0.03 |
| Comparative | 4.4 | 0.00 | 5.88 | 0.00 | 674.3 | 1.27 | 0.00 | 5.76 | 0.00 |
| Example 1 | | | | | | | | | |
| Comparative | 23.3 | 0.75 | 5.13 | 0.13 | 617.6 | 1.28 | 0.58 | 5.77 | 0.09 |
| Example 2 | | | | | | | | | |
| Comparative | 25 | 1.00 | 4.88 | 0.17 | 504.0 | 1.26 | 0.73 | 5.78 | 0.11 |
| Example 3 | | | | | | | | | |
| Comparative | 22.9 | 0.75 | 5.13 | 0.13 | 645.2 | 1.28 | 0.55 | 5.78 | 0.09 |
| Example 4 | | | | | | | | | |

It could be confirmed in Table 1 that in the samples of Examples 1 to 3, the coercive force is enhanced while suppressing a reduction in the residual magnetization. It could be confirmed in FIG. 2 and FIG. 3 that when the content ratio of C in the modifier becomes excessive, the content ratio of Nd (rare earth element other than light rare earth elements) in the modifier is relatively reduced and the coercive force decreases. It could be confirmed in FIG. 4 that an element (Cu) decreasing the melting point of the rare earth magnet, which the modifier contains, may be contained as long as it is within a predetermined range. It could be confirmed in FIG. 5 that the carbon having diffused and penetrated into the grain boundary phase is forced to diffuse into the shell portion. Here, since the carbon is considered not to diffuse and penetrate deep into the core portion of the main phase, the analysis values in the core portion are baselines.

From these results, the effects of the R-T-B-based rare earth magnet of the present disclosure and the manufacturing method thereof could be confirmed.

### REFERENCE SIGNS LIST

10 Main phase
12 Core portion
14 Shell portion
20 Grain boundary phase
100 R-T-B-based rare earth magnet of the present disclosure

1. An R-T-B-based rare earth magnet in which R is a rare earth element, T is at least either Fe or Co, and B is boron, the R-T-B-based rare earth magnet comprising
a main phase having an R₂T₁₄B-type crystal structure and
a grain boundary phase present around the main phase,
wherein
the average grain size of the main phase is from 1.0 to 10.0 μm, the main phase has a core portion and a shell portion present around the core portion,
the total content ratio of cerium, lanthanum, yttrium and scandium is higher in the core portion than in the shell portion,
the total content ratio of neodymium, praseodymium, gadolinium, terbium, dysprosium and holmium is higher in the shell portion than in the core portion,
the R-T-B-based rare earth magnet contains from 0.05 to 0.50 at % of carbon, and the content ratio of the carbon is higher in the grain boundary phase than in the main phase.

2. The R-T-B-based rare earth magnet according to claim 1, wherein the carbon content ratio is higher in the shell portion than in the core portion.

3. The R-T-B-based rare earth magnet according to claim 1, wherein in the shell portion, denoting, in at %, as [C] the carbon content ratio and as [B] the boron content ratio relative to all of the constituent elements of the shell portion, [C] is from 0.25 to 0.75 at % and [C]/([C]+[B]) is from 0.04 to 0.10.

4. The R-T-B-based rare earth magnet according to claim 1, wherein the average grain size of the main phase is from 4.0 to 10.0 μm.

5. A production method of an R-T-B-based rare earth magnet, comprising
allowing a modifier to diffuse and penetrate into a rare earth magnet precursor, wherein
the rare earth magnet precursor essentially contains, as rare earth elements, one or more elements selected from the group consisting of cerium, lanthanum, yttrium and scandium and has a main phase having an R₂T₁₄B-type crystal structure and a grain boundary phase present around the main phase, the average grain size of the main phase being from 1.0 to 10.0 μm,
the modifier contains from 90 to 95 at % of one or more elements selected from the group consisting of neodymium, praseodymium, gadolinium, terbium, dysprosium and holmium and from 5 to 10 at % of carbon, and
from 1.0 to 5.0 mol of the modifier is allowed to diffuse and penetrate per 100 mol of the rare earth magnet precursor.

6. The production method of an R-T-B-based rare earth magnet according to claim 5, wherein the modifier further contains 5 at % or less of one or more elements other than rare earth elements, and the one or more elements other than rare earth elements are alloyed with one or more elements selected from the group consisting of neodymium, praseodymium, gadolinium, terbium dysprosium and holmium.

7. The production method of an R-T-B-based rare earth magnet according to claim 5, wherein the average grain size of the main phase is from 4.0 to 10.0 μm.
